(19) United States
(12) Patent Application Publication
(10) Pub. No.: US 2015/0186960 A1
(43) Pub. Date: Jul. 2, 2015

(54) Multi-Item Access of Pricing Condition Tables

(71) Applicant: Thomas Veit, Kirchheimbolanden (DE)

(72) Inventor: Thomas Veit, Kirchheimbolanden (DE)

(73) Assignee: SAP AG, Walldorf (DE)

(21) Appl. No.: 14/145,209

(22) Filed: Dec. 31, 2013

(51) Int. Cl. G06Q 30/02; G06F 17/30; G06Q 30/04

(52) U.S. Cl. CPC G06Q 30/0283; G06Q 30/04; G06F 17/3048

(57) ABSTRACT

Various embodiments herein each include at least one of systems, methods, and software for multi-item access of pricing condition tables. Such embodiments generally retrieve applicable pricing conditions from each relevant pricing condition table in a single query for each product included in an order or invoicing document, or other document within which pricing data is provided. The retrieved pricing condition data may then be written to a buffer in memory and utilized in pricing products included in an order or invoice document. Such embodiments generally reduce a number of queries that are executed against pricing condition tables thereby increasing the efficiency of pricing activities.

### BACKGROUND INFORMATION

The aim of pricing is automatic transfer of price elements, such as prices, discounts, surcharges, and taxes, into a document. Pricing generally takes place in generation of ordering and invoicing documents. Price elements are factors with regard to each item or each of a quantity of an item being ordered or invoiced. However, there may also be price elements that are applicable to an order or invoice as a whole, such as sales tax, company discounts, and the like.

The price elements can be dependent on any number of conditions of a document, such as an order or invoice document, being created. For example, such conditions may simply include a product condition where a product has a single price. However, the other conditions may be dependent upon factors such as a customer identity, an affiliation of customer with a favored group, a geographic location of the customer (e.g., country specific pricing and local sales tax), one or more contracts or other agreements with the customer, a document date, a product quantity ordered or purchased, and the like.

As pricing elements may be specific to individual products, the pricing element of each product is typically considered individually along with its conditions to determine pricing for the product and the quantity thereof represented in the document. Also, as pricing elements may be document specific, rather than product specific, a sum of product pricing elements, once determined, may then be considered to identify and apply additional pricing elements, and conditions thereof, in arriving at net pricing element for the document.

Additionally, pricing elements may have many conditions, each condition having a different validity period. However, when a price is being determined only condition records that are currently valid are utilized. Pricing is also typically performed according to a defined sequence according to procedures that are logically defined. In some embodiments, a single procedure may be defined. However, in other embodiments, customers or groups of customers may be assigned specific or general pricing procedures.

Regardless, price elements of a document to date have generally been determined one element at a time. Further, as discussed, single pricing elements may have many different factors for consideration in reaching a final price for the particular price element. Each of these factors has also been considered individually with each factor requiring a retrieval of data from a pricing data repository, such as a file or a database. As a result, each price element often requires multiple data retrievals. In a batch job invoice or order document generation scenario, the number of retrievals can be quite large, adding considerable time to execution of the batch job.

### BRIEF DESCRIPTION OF THE DRAWINGS

FIG. 1 is a logical block diagram of a system, according to an example embodiment.

FIG. 2 is a data relation diagram of stored data elements, according to an example embodiment.

FIG. 3 is a logical illustration of data retrieval, according to an example embodiment.

FIG. 4 is a block flow diagram of a method, according to an example embodiment.

FIG. 5 is a block diagram of a computing device, according to an example embodiment.

### DETAILED DESCRIPTION

Various embodiments herein each include at least one of systems, methods, and software for multi-item access of pricing condition tables. Such embodiments generally retrieve applicable pricing conditions from each relevant pricing condition table in a single query for each product included in a document being processed or created, such as an order or invoicing document, a purchase order, a sales quotation, a price inquiry such as for pricing products presented in a web page of an online store, or other document within which pricing data is provided. Note that although many locations herein refer only to invoicing or order documents and associated processes, such references are made in the interest of brevity, rather than repeating the litany of possible documents that the various embodiments may be relevant for, and are not to be considered limiting. The retrieved pricing condition data may then be written to a buffer in memory and utilized in pricing products included in a document. Such embodiments generally reduce a number of queries that are executed against pricing condition tables thereby increasing the efficiency of pricing activities. In some embodiments, such as batch invoice generation, a large number of products to be billed in many invoices to be generated may be identified prior to retrieving pricing condition data from the pricing condition tables. Again, this data may be written to a buffer in memory and utilized in pricing products included in each of the invoices to be generated. Such embodiments may provide significant performance enhancements in pricing activities with regard to invoice generation as the number of queries submitted to a database can be greatly reduced. Details of such embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

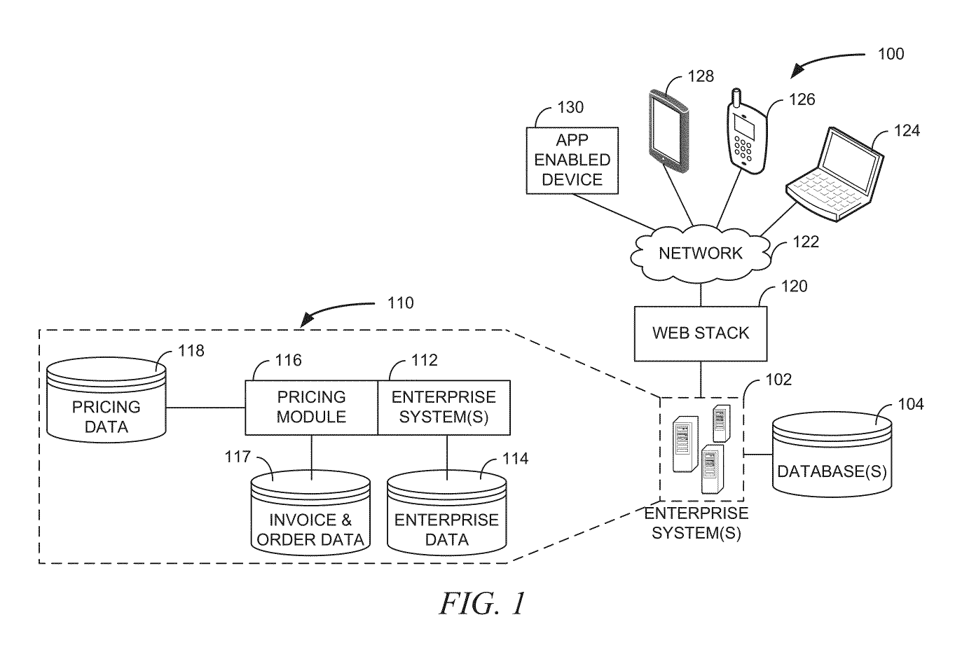

FIG. 1 is a logical block diagram of a system 100, according to an example embodiment. The system 100 typically includes at least one enterprise system 102 deployed on one or more servers. The enterprise system 102, in some embodiments, is an Enterprise Resource Planning (ERP) system, such as are available from SAP AG, of Walldorf, Germany. In other embodiments, in addition to an ERP system, the enterprise system may alternatively, or also, include one or more of a Customer Relationship Management (CRM) system, a Human Resources Management (HRM) system, an accounting and finance system, and other such systems.

The enterprise system 102 may store data in one or more databases 104. In some embodiments, the enterprise system 102 may include various elements 110. The elements of the enterprise system 102 may include one or more enterprise systems 112, such as are enumerated above. The elements may also include a pricing module 116 that is executable to price products and other items included in price quotes, orders, invoices, and other documents. The one or more databases 104 of the enterprise system 102 may include elements 110, such as an enterprise data database 114 that may store enterprise system 112 configuration data, master data, content, and transaction data. The one or more databases 104 may further include an invoicing and order data database 117 and a pricing data database 118. In some embodiments, all of the enterprise data database 114, invoicing data database 117, and pricing data database 118 may be included within the one or more databases 104 of the enterprise system 102.

The enterprise system 102 may also be connected to a network 122, either directly or via a web stack 120, such as a web server, an application server, and various other servers and networking devices. The enterprise system 102 may be connected to the network 122 to provide data processing services of the enterprise system 102 to users in a cloud-based arrangement. In other embodiments, the enterprise system 102 may provide access and data processing services of the enterprise system 102 and data stored thereby to users of personal computers 124, mobile devices such as smart phones 126 and tablets 128, and other app enabled devices 130. In some embodiments, pricing data may be generated by the pricing module 116 for inclusion in web pages or app data servicing communications sent via the network 122 in response to requests received therefrom. Additionally, the enterprise system 102 may generate invoices, order documents, pricing quotes, and other such documents in an electronic form and transmit them via the network 122.

In some embodiments, the network 122 is representative of one or both of wired and wireless networks. The wired and wireless networks may include one or more of each of a local area network, a wide area network, a system area network, a storage area network, a virtual private network, a value added network, a global data network, the Internet, and other such networks.

In some embodiments, the enterprise system 112 includes an invoice and order document generating process that may be called by other processes. Note however that the enterprise system 112 may include other or addition processes in different embodiments that may utilize the pricing functionality described herein. Thus, the described invoicing and order document generating process is provided as one possible example of a process that utilizes the pricing functionality.

The invoice and order document generating process may receive an identifier of an invoice or order document to generate, an identifier of a customer, identifiers of a number of products to include, and a quantity of each product. Based on this data, the invoice and order document generating process will generate an invoice or order document.

To generate the invoice or order, the invoice and order document generating process may identify an invoice or order document template to populate with data based on a customer for which the document is to be generated. The document template may be identified, in some embodiments, by retrieving customer data based on the received customer identifier, the received invoice or order identifier, and enterprise system 112 configuration data. Once the document template is identified, the document template may be retrieved.

Once retrieved, the document template is evaluated to determine customer master data to include in the document template. For example, the document template may identify various data elements to be included in the document, such as a customer name, customer contact, customer address, customer phone number, and other such data of the customer. The customer data may also include data of a sales person, support function, and the like of an entity for which the enterprise system 102 operates. The determined customer master data may then be retrieved based on the data included in the document template and the customer identifier and populated into the document template.

Next, the invoice and order document generating process may populate the retrieved document template with the received product identifiers and respective quantities. The document template may further identify additional product data to be included in the document, such as product descriptions, product details such as shipping weights, number of included units, and the like. This additional data may be retrieved for each product based on respective product identifiers and populated into the document template.

The invoicing and order generating process may then determine pricing data for each of products added to the document template. Pricing of products in such documents to date has generally been performed on a line-by-line basis where data that contributes to a price for each product is retrieved one element at a time. For example, a base price may be retrieved followed by a retrieval of data representative of each of a plurality of possible pricing conditions that might apply. A query is typically performed with regard to each possible pricing condition, even when the result is that the pricing condition does not apply. After several queries are performed with regard to a first product included in such a document, the queries are typically performed again with regard to many, if not all, of the same pricing conditions. When many products are included in the document, the number of queries performed can be quite large. When the number of products is relatively low, the added latency from performing the queries may not be noticeable to a user or within overall system 100 performance. However, as the number of products grows, latency in the system 100 may become noticeable to the user. Additionally, when documents are being generated as part of a batch document generation process, the batch job may be significantly delayed. As batch jobs typically have a finite window within which they are allowed to execute, latency added by a large number of queries may become a batch job scheduling issue.

In various embodiments herein, such as the present embodiment, a single query is performed to retrieve pricing condition data from each relevant pricing condition table regardless of the number of products included in the document rather than at least once for each product. In the present embodiments, the number of queries performed will typically be equal to the number of pricing condition tables storing the needed data. Further, in batch processing, prior to performing queries against the pricing condition tables, the pricing condition data for a portion or an entirety of a batch job may be determined, in some embodiments, to identify where multiple accesses of pricing condition tables would otherwise be made and the redundant accesses are eliminated. In these embodiments, as pricing condition data is retrieved, the pricing condition data is written to a data structure buffered in memory. The pricing condition data buffered to memory is then utilized in performing pricing determinations thereby further reducing a number of costly database queries that are performed.

Returning to the present embodiment, to obtain pricing data to populate document template, the invoicing and order generating process calls one or more functions or services of the pricing module 116. The pricing module 116 executes to determine a price for each item of the document template, a total price to include in the document, and other pricing elements as may be required or otherwise needed for population into the document template, such as a gross price, a sales tax amount, any additional taxes or surcharges, and the like.

The pricing module 116 may first determine a pricing procedure for a document based on at least one of the document type of the document template and the customer for which the document is being generated. The pricing procedure identifies a number of pricing condition types to be applied in a sequenced order to each product included in the document and possibly pricing condition types to be applied to the document as a whole, such as a sales tax amount, duties, processing and handling charges, and the like. The condition types are the technical representations of the pricing elements mentioned before.

Each identified condition type is then utilized by the pricing module 116 to identify an access sequence of specific pricing condition tables storing data identifying pricing condition records to be retrieved when a pricing condition is applicable to a product included in the document. Once the pricing condition tables are identified for each pricing condition type, the pricing condition tables may be queried in an order according to the identified access sequence.

When querying a first pricing condition table of the identified access sequence for the respective pricing condition type, the pricing module 116 generates and submits a single query against the respective pricing condition table. This single query is submitted to retrieve a pricing condition record identifier for each product added to the document template. However, the query may not return a pricing condition record identifier for each product added to the document template. Data representative of the pricing condition type and a pricing condition record identifier for each product for which a pricing condition record is retrieved is written to a first data structure in a memory. Then the pricing module 116 generates a next query against a next pricing condition table of the identified access sequence for each product added to the document template for which a pricing condition record identifier has not yet been retrieved. Pricing condition table records are then received in response to this query and data representative of the pricing condition type and the pricing condition record identifiers are written to the first data structure in memory with regard to the respective products for which they were retrieved. This process of generating a next query against a next pricing condition table for products for which a pricing condition table record has not yet been retrieved continues until all tables of the identified access sequence have been queried or until a pricing condition record identifier has been retrieved for each of the products added to the document template and written to the first data structure in memory. Once the pricing module 116 completes the processing of products for a pricing condition type and the associated data structures have had the data as described above written to them, a next condition type is processed.

In some embodiments, pricing condition records may include various data elements. In a simple embodiment, pricing condition records may include a condition record identifier, a value or price, and a currency of the value or price. However in some such embodiments, the condition records may further include a scale indicator, which may be a Boolean value or other value that indicates that the pricing condition record includes additional associated data of a pricing scale, such as may be applied based on quantities of a product of the respective document being priced, a total price of all products of the document, and the like. Generally, such scales may be applied for volume or spending amount discounts. Thus, when a condition record includes data indicating a pricing scale may be applicable, pricing data for the respective pricing condition record is applicable to a pricing calculation, such as from an additional table that stores pricing condition scale data.

Once all condition types have been processed, pricing condition records may then be retrieved and written into a second data structure in memory. In some such embodiments, all pricing condition record identifiers are gathered from the first data structure stored in memory and a single query is generated and submitted to retrieve pricing condition records. The retrieved pricing condition records are then written to the second data structure in memory. In some embodiments, the single query that is generated may be generated to join a condition scale table for pricing condition records having data indicating associated pricing scale data is present and the pricing scale data may be retrieved in the single query and written to the second data structure in memory. In other embodiments, once the pricing condition records have been retrieved and written to the second data structure in memory, another single query may be generated to retrieve pricing condition scale records for each retrieved pricing record including data indicating associated pricing scale data is present. This retrieved pricing scale data may then be written to the second data structure in memory or may be written to a third data structure in memory in other embodiments.

Once all condition types have been processed and all condition data structures are stored in memory, the pricing of products may then be performed based on the buffered data. Note however that some embodiments may include parallel processing. For example, some embodiments may include processing two or more pricing condition types in parallel. In some such embodiments, and others, once the pricing module 116 completes processing products for a pricing condition type, the pricing of products for that pricing condition type may begin while at the same time, the pricing module 116 generates a data structure in memory, or adds data to the existing data structure, for the next pricing condition type.

The pricing of each product will include at least one pricing condition type, such as a base price, plus any additional markups, surcharges, and taxes, less any discounts, promotions, and the like. The pricing procedure retrieved earlier in the processing by the pricing module 116 identifies the sequence for applying the pricing conditions. At the same time, the first data structure that is buffered in memory includes data identifying a pricing condition type and a pricing condition record with regard to each product. Thus, to price each product added to the document template, the pricing module 116 retrieves, from the data structure in memory, a pricing condition record identifier for each pricing condition of the pricing procedure for the respective product. The pricing module 116 then retrieves the pricing condition records from the second data structure in memory based on the pricing condition record identifiers. Each pricing condition record is then evaluated to identify a pricing element for each pricing condition type. For example, a pricing condition record for a base price of a product may identify a price with regard to a quantity of one to five units having a price per unit of $100 and a quantity of six or more having a price per unit of $90. Similarly, a pricing condition record for freight charges may identify a freight charge for one to five units of $10 per unit and no charge for six or more units. Once a pricing element for each pricing condition type is determined, the pricing module 116 will sum the pricing elements and add the sum to the document template. In some embodiments, the pricing module 116 may add details of the pricing activity with regard to the product, such as may be identified for inclusion in the document template.

Once all products added to the document template have been priced, the pricing module 116 may then determine a gross price and apply any additional pricing condition types, such as sales tax, processing fees, invoice or order surcharges, and the like. A total may then be summed and added to the document template. In some embodiments, the pricing module 116 has completed processing of the document template and will return the document template to the invoicing and order generating process. The invoice and order document generating process will then typically store the document and may further queue the document for dispatch to the customer. In some embodiments, the document may be provided via the network 122 to a requesting customer application or app.

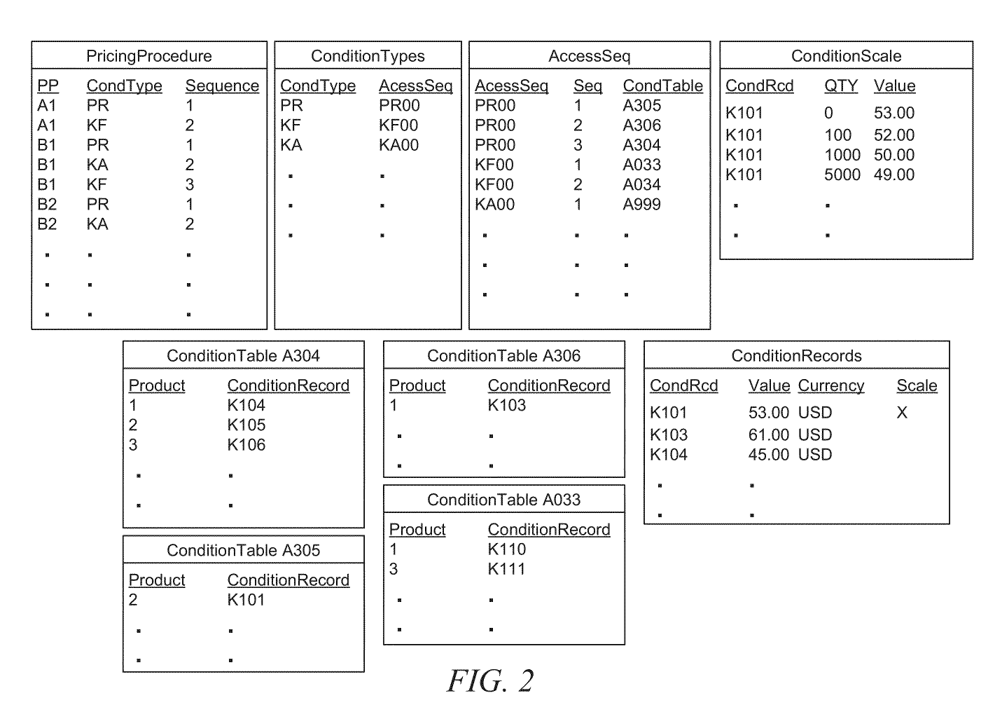

FIG. 2 is a data relation diagram of stored data elements, according to an example embodiment. The data relation diagram of FIG. 2 illustrates one example embodiment of database tables within which data representative of pricing procedures, condition types, access sequences, condition tables, condition records, condition scales, and relations there between, maybe stored. Although the tables illustrated in FIG. 2 are illustrated as including certain data columns, some embodiments may include a smaller or larger number of data columns, depending on the particular embodiment. In some embodiments, the database tables of FIG. 2 may be stored in the pricing data database 118.

The PricingProcedure table stores rows of data representative of pricing procedures. A pricing procedure may be defined by one or more rows of data. For example, pricing procedure “A1” is defined by two rows of data. The pricing procedure includes two pricing condition types “PR” and “KF” and is sequenced in that order.

The ConditionTypes table associates condition types of pricing procedures to access sequences stored in the AccessSeq table. For example, the AccessSeq table stores data defining an access sequence “PR00” that identifies an ordered sequence for access pricing condition tables “A305”, “A306”, and “A304”, in that order. The ConditionTypes table associates the condition type “PR” of the PricingProcedure Table to this access sequence “PR00” of the AccessSeq table.

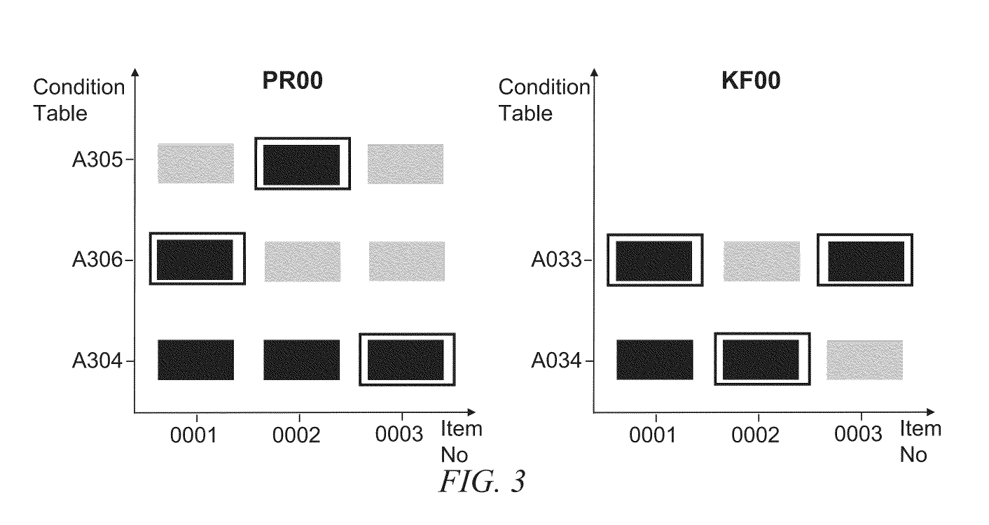

The data of the AccessSeq table identifies an access sequence of condition tables from which to retrieve pricing conditions for products, such as described above with regard to the pricing module. For access sequence “PR00”, the access sequence defined in the data of the AccessSeq table is condition tables, in sequence, “A305”, “A306”, and “A304”. In the description above, retrieval of a condition record identifier for each product is attempted from the first condition table of the access sequence. Then in subsequent retrievals, retrieval is attempted only for condition record identifiers of products for which a condition record identifier has not yet been retrieved. Thus, the retrieval result according to access sequence “PR00” is Product 1: K103; Product 2: Condition Record K101; Product 3: K106. This retrieval result, as linked through the data of the various tables as illustrated and described above, is with regard to condition type “PR”. Thus, in some embodiments such as in the embodiment described above, a data structure held in memory will have rows of data including columns. The columns are condition type, product 1, product 2, and product 3, where an invoice or order document includes three products. The result of the retrieval will be written to the data structure as “PR”, “K103”, “K101”, “K106”. FIG. 3 includes another representation of data retrieval, according to some embodiments.

FIG. 3 is a logical illustration of data retrieval, according to an example embodiment. The logical illustration includes a representation of pricing condition types PR00 and KF00. Each pricing condition includes product item numbers on the horizontal axis and condition table identifiers on the vertical access. The condition table identifiers are illustrated according to a table access sequence, such as is represented in the AccessSeq table of FIG. 2. A first condition table to access is at the top of the vertical axis of each of the pricing condition types “PR00” and “KF00”. A next condition table to access is the next condition table below, and so forth. The boxes illustrated in FIG. 3 at the intersections of product item numbers and condition tables represent data. The black boxes represent intersections where data is stored, while the grey boxes represent intersections where no data is stored.

As described above, when a first query is submitted against a pricing condition table of a sequence of pricing condition tables, the query is submitted with regard to all product items that are to be priced. Thus, for pricing condition type PR00 and with regard to condition table A305, the query is submitted with regard to each of products 0001, 0002, and 0003. The result of this query is retrieval of data only with regard to product 0002. A second query is then prepared for the remaining products 0001 and 0003 against the next pricing condition table A306. This query is submitted and results in retrieval of data only for product 0001. A third query is then prepared with regard to the remaining product 0003 against pricing condition table A304. This query results in retrieval of data with regard to product 0003. Note that although there is data stored at the intersections of both product 0001 and 0002 with pricing condition table A304, that data is not retrieved as pricing condition data has already been retrieved with regard to both products 0001 and 0002.

Turning now to the illustration of pricing condition type KF00, a first query is prepared and submitted against pricing condition table A033 for each of products 0001, 0002, and 0003. The result of this single query is a retrieval of data with regard to both products 0001 and 0003. A next query is then prepared with regard to only product 0002 as data has already been retrieved for both products 0001 and 0003. The next query is then submitted against pricing condition table A034 and data is retrieved with regard to product 0002. Again, note that although there is data stored at the intersection of product 0001 and pricing condition table A034, that data is not retrieved as data had previously been retrieved for the product 0001.

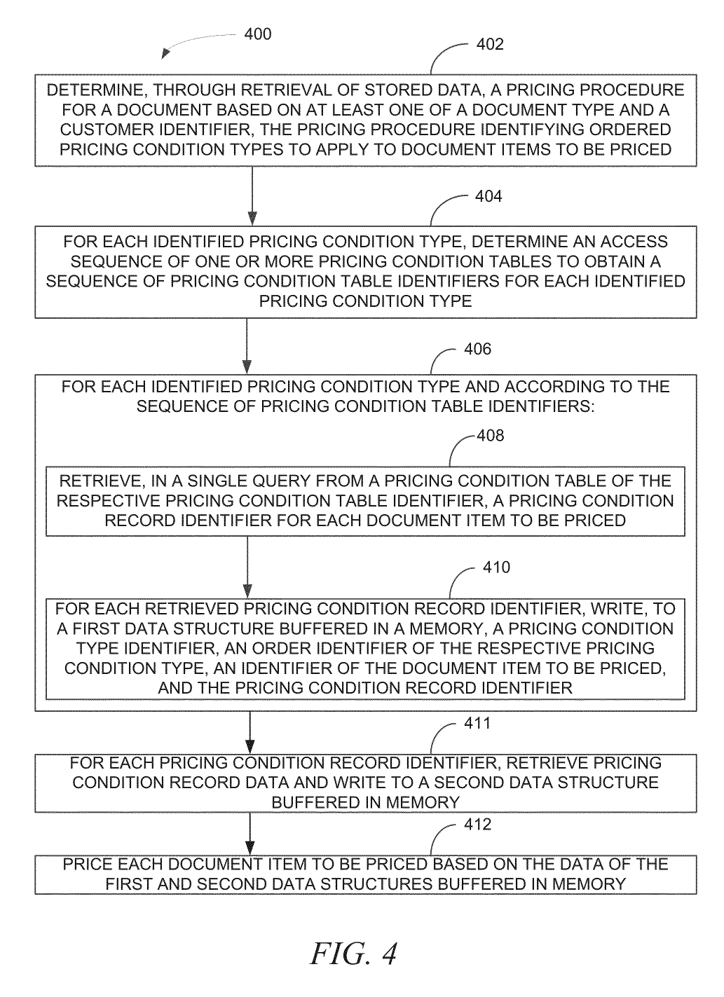

FIG. 4 is a block flow diagram of a method 400, according to an example embodiment. The method 400 may be performed, for example, by a pricing module 116 as illustrated and described with regard to FIG. 1.

The method 400 includes determining 402 a pricing procedure for a document based on at least one of a document type and a customer identifier. The pricing procedure typically identifies ordered pricing condition types to apply to document items to be priced, such as a general price condition type followed by other condition types, which may include discounts, freight charges, and the like. The method 400, for each identified pricing condition type, may then determine 404 an access sequence of one or more pricing condition tables to obtain a sequence of pricing condition table identifiers for each identified pricing condition type.

Subsequently, the method 400, for each 406 identified pricing condition type and according to the sequence of pricing condition table identifiers retrieves 408, in a single query from a pricing condition table of the respective pricing condition table identifier, a pricing condition record identifier for each document item to be priced. Then for each retrieved pricing condition record identifier, some embodiments include writing 410, to a first data structure buffered in a memory, at least some of a pricing condition type identifier, an order identifier of the respective pricing condition type, an identifier of the document item to be priced, the pricing condition record identifier, and data indicating whether the pricing condition record is subject to scaled pricing.

In some scaled pricing embodiments, data of a pricing condition record may include an indicator of whether the pricing condition record is the subject of scaled pricing, such as for pricing based on volume (e.g., for up to five units, the price is $50.00 each; for six to ten units, the price is $48.00 each, etc.). In some such embodiments, pricing condition records may include a data column storing a Boolean value indicating whether the pricing condition record is subject to scaled pricing.

Continuing with the method 400, after each pricing condition type has been processed, the method 400 may then retrieve 411 and write to a second data structure buffered in memory, pricing condition records for each pricing condition record identifier in the first data structure buffered in memory. In some embodiments, the retrieved pricing record data may include data indicating the respective pricing condition record is subject to scaled pricing. In some such embodiments, the retrieval 411 of the pricing condition record data is made in a single query. Additionally, when there are pricing condition records including an indicator that there is associated scaled pricing data, a single query may be made, which may include one or more table joins, to retrieve the associate scaled pricing data in the same query. In another embodiment, following the retrieval 411 and writing of the pricing condition record data to the second data structure buffered in memory, another query may be generated and issued to retrieve the associated scaled pricing data. For example, the first data structure buffered in memory may contain pricing condition record identifiers of several pricing condition records having an indicator that scaled pricing data exists. The pricing condition record identifiers of these pricing condition records may be gathered and formed into a single query of pricing condition scale data, such as from the ConditionScale table of FIG. 2. The result of such a query will typically be a plurality of rows for each of the pricing condition record identifiers, where each row includes pricing condition scale data and a pricing data element. The retrieved pricing condition scale data may then be written to a third data structure buffered in memory or to the second data structure buffered in memory, depending on the particular embodiment. The method 400 may then price 412 each document item to be priced based on the data of the first and second data structures buffered in memory and, when relevant and present in memory, in view of scaled pricing data of the second data structure, or the third data structure depending on the embodiment, buffered in memory.

For example, in some embodiments, when pricing 412 each document item, a pricing condition record of the first data structure buffered in memory may indicate that the relevant pricing condition is a scaled pricing condition. In some such embodiments, subsequent to the retrieving 408 of pricing condition records the retrieved data is written to the first data structure buffered in memory. Once all relevant pricing condition records have been retrieved and written to the first data structure buffered in memory, the pricing condition record identifiers may be retrieved from first data structure buffered in memory. The pricing condition record identifiers may be formed into a single query to retrieve 411 the pricing condition record data, which is then written to the second data structure buffered in memory. Data of the pricing condition records is retrieved from one or both of the first and second data structures and is evaluated to identify pricing condition records that are subject to price scaling, such as by considering a Boolean value of a “SCALE” data column of the pricing condition record. When subject to price scaling, the respective pricing condition record identifier may be utilized to retrieve pricing condition scale data, such as from the “ConditionScale” table of FIG. 2. The pricing condition scale data in such embodiments may then be retrieved and buffered in the second data structure buffered in memory, or written to a third data structure buffered in memory depending on the embodiment, prior to performing the pricing 412 of each document item, or prior to performing the pricing 412 of the specific item to be priced.

In some embodiments of the method 400, the document is an invoice to be generated for each of a plurality of customers where each of the customers has at least one document item to be priced. In such embodiments, determining 402 a pricing procedure for the document based on the at least one of the document type and the customer identifier includes determining a pricing procedure for each of the plurality of customers for which an invoice is to be generated. Further, the pricing procedure for each of the plurality of customers identifies a sequence of pricing condition types to apply to document items to be priced for the respective customer. In some such embodiments, data is written to a second data structure buffered in the memory for each customer of the plurality of customers. The data written to the second data structure includes data representative of the respective customer, pricing condition types to be applied to document items, and data representative of the sequence the pricing condition types are to be applied. In some such embodiments, the retrieving 408, in the single query from the pricing condition table, of the respective pricing condition table identifier is performed with regard to each document item of each of the plurality of customers. Note that although the first and second data structures are described as distinct data structures, in other embodiments the data may instead be written to a single data structure.

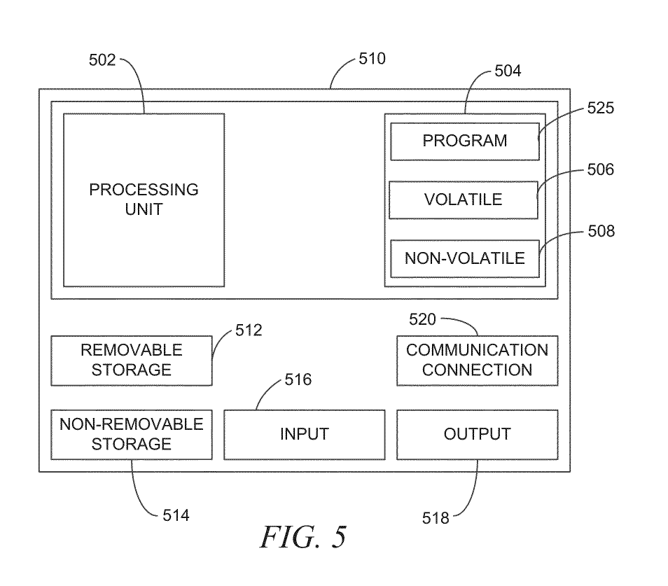

FIG. 5 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 510, may include a processing unit 502, memory 504, removable storage 512, and non-removable storage 514. Although the example computing device is illustrated and described as computer 510, the computing device may be in different forms in different embodiments. For example, the computing device may instead be a smartphone, a tablet, or other computing device including the same or similar elements as illustrated and described with regard to FIG. 5. Further, although the various data storage elements are illustrated as part of the computer 510, the storage may also or alternatively include cloud-based storage accessible via a network, such as the Internet.

Returning to the computer 510, memory 504 may include volatile memory 506 and non-volatile memory 508. Computer 510 may include—or have access to a computing environment that includes a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 510 may include or have access to a computing environment that includes input 516, output 518, and a communication connection 520. The input 516 may include one or more of a touchscreen, touchpad, mouse, keyboard, camera, and other input devices. The computer may operate in a networked environment using a communication connection 520 to connect to one or more remote computers, such as database servers, web servers, and other computing device. An example remote computer may include a personal computer (PC), server, router, network PC, a peer device or other common network node, or the like. The communication connection 520 may be a network interface device such as one or both of an Ethernet card and a wireless card or circuit that may be connected to a network. The network may include one or more of a Local Area Network (LAN), a Wide Area Network (WAN), the Internet, and other networks.

Computer-readable instructions stored on a computer-readable medium are executable by the processing unit 502 of the computer 510. A hard drive (magnetic disk or solid state), CD-ROM, and RAM are some examples of articles including a non-transitory computer-readable medium. For example, various computer programs 525 or apps, such as one or more applications and modules implementing one or more of the methods illustrated and described herein or an app or application that executes on a mobile device or is accessible via a web browser, may be stored on a non-transitory computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
determining, through execution of instructions on at least one processor of at least one computing device, a pricing procedure for a document based on at least one of a document type and a customer identifier, the pricing procedure identifying ordered pricing condition types to apply to document items to be priced;
for each identified pricing condition type, determining an access sequence of one or more pricing condition tables to obtain a sequence of pricing condition table identifiers for each identified pricing condition type;
for each identified pricing condition type and according to the sequence of pricing condition table identifiers:
retrieving, in a single query from a pricing condition table of the respective pricing condition table identifier, a pricing condition record identifier for each document item to be priced; and
for each retrieved pricing condition record identifier, writing, to a first data structure buffered in a memory, a pricing condition type identifier, an order identifier of the respective pricing condition type, an identifier of the document item to be priced, and the pricing condition record identifier; and
for each pricing condition record identifier included in the first data structure buffered in memory, retrieving pricing condition record data and writing the retrieved data to a second data structure buffered in memory;
pricing each document item to be priced based on the data of the first and second data structures buffered in memory.

2. The method of claim 1, wherein for each identified pricing condition type with regard to each document item to be priced, the retrieving of the pricing condition record identifier from the pricing condition tables is performed according to the sequence of pricing condition table identifiers until a pricing condition record identifier has been retrieved for the respective document item to be priced, after which, pricing condition record identifiers are retrieved only for document items to be priced for which a pricing condition record identifier has yet to be retrieved.

3. The method of claim 1, wherein:
retrieving pricing condition record data includes retrieving scaled pricing data for each pricing condition record identifier including a price scaling indicator indicating there is associated scaled pricing data and writing the scaled pricing data to a third data structure buffered in memory; and
pricing each document item to be priced, when a document item is subject to scaled pricing as indicated by a price scaling indicator, includes selecting, for a respective item to be priced, a price from the scaled pricing data written to the third data structure buffered in memory.

4. The method of claim 1, wherein:
the document is an invoice to be generated for each of a plurality of customers, each of the plurality of customers including at least one document item to be priced;
determining a pricing procedure for the document based on the at least one of the document type and the customer identifier includes:
determining a pricing procedure for each of the plurality of customers for which an invoice is to be generated; and
the pricing procedure for each of the plurality of customers identifying a sequence of pricing condition types to apply to document items to be priced for the respective customer; and
for each customer of the plurality of customers, writing, to a third data structure buffered in the memory, data representative of the respective customer, pricing condition types to be applied to document items, and data representative of the sequence the pricing condition types are to be applied.

5. The method of claim 4, wherein the retrieving, in the single query from the pricing condition table of the respective pricing condition table identifier, is performed with regard to each document item of each of the plurality of customers.

6. The method of claim 4, wherein the first and third data structures are the same data structure.

7. The method of claim 1, wherein the identified ordered pricing condition types include a document item price condition type, at least one document item discount condition type, and at least one document item legal condition type.

8. A non-transitory computer-readable medium, with instructions stored thereon, which when executed by at least one processor of a computing device, causes the computing device to:
determine, through retrieval of stored data, a pricing procedure for a document based on at least one of a document type and a customer identifier, the pricing procedure identifying ordered pricing condition types to apply to document items to be priced;
for each identified pricing condition type, determine an access sequence of one or more pricing condition tables to obtain a sequence of pricing condition table identifiers for each identified pricing condition type;
for each identified pricing condition type and according to the sequence of pricing condition table identifiers:
retrieve, in a single query from a pricing condition table of the respective pricing condition table identifier, a pricing condition record identifier for each document item to be priced;
retrieving, in a single query, data of pricing condition records of each pricing condition identifier, the data of each pricing condition record including at least one of price data and an indicator of whether scaled pricing data exists for the pricing condition; and
for each retrieved pricing condition record, write, to a first data structure buffered in a memory, a pricing condition type identifier, an identifier of the document item to be priced, the pricing condition record identifier, and the indicator of whether scaled pricing data exists for the pricing condition record;
for all pricing condition records of the first data structure buffered in memory, retrieving, in a single query, pricing data and writing the retrieved pricing data to a second data structure buffered in memory;
price each document item to be priced based on the data of the first and second data structures buffered in memory.

9. The non-transitory computer-readable medium of claim 8, wherein for each identified pricing condition type with regard to each document item to be priced, the retrieving of the pricing condition record identifier from the pricing condition tables is performed according to the sequence of pricing condition table identifiers until a pricing condition record identifier has been retrieved for the respective document item to be priced, after which, pricing condition record identifiers are retrieved only for document items to be priced for which a pricing condition record identifier has yet to be retrieved.

10. The non-transitory computer-readable medium of claim 8, wherein retrieving the pricing data in the single query includes retrieving scaled pricing data for each pricing condition record including an indicator that scaled pricing data exists.

11. The non-transitory computer-readable medium of claim 8, wherein:
the document is an invoice to be generated for each of a plurality of customers, each of the plurality of customers including at least one document item to be priced;
determining a pricing procedure for the document based on the at least one of the document type and the customer identifier includes:
determining a pricing procedure for each of the plurality of customers for which an invoice is to be generated; and
the pricing procedure for each of the plurality of customers identifying a sequence of pricing condition types to apply to document items to be priced for the respective customer; and
the instructions which when further executed by the at least one processor, for each customer of the plurality of customers, causes the computing device to:
write, to a third data structure buffered in the memory, data representative of the respective customer, pricing condition types to be applied to document items, and data representative of the sequence the pricing condition types are to be applied.

12. The non-transitory computer-readable medium of claim 11, wherein the retrieving, in the single query from the pricing condition table of the respective pricing condition table identifier, is performed with regard to each document item of each of the plurality of customers.

13. The non-transitory computer-readable medium of claim 11, wherein the first and third data structures are the same data structure.

14. The non-transitory computer-readable medium of claim 8, wherein the identified ordered pricing condition types include a document item price condition type, at least one document item discount condition type, and at least one document item legal condition type.

15. A system comprising:
at least one processor;
at least one memory; and
an instruction set accessible in the at least one memory and executable by the at least one processor to:
identify, through retrieval of data stored on the at least one memory device, a pricing procedure for a document based on at least one of a document type and a customer identifier, the pricing procedure identifying ordered pricing condition types to apply to document items to be priced;
for each identified pricing condition type, determine an access sequence of one or more pricing condition tables to obtain a sequence of pricing condition table identifiers for each identified pricing condition type;
for each identified pricing condition type and according to the sequence of pricing condition table identifiers:
retrieve, in a single query from a pricing condition table of the respective pricing condition table identifier, a pricing condition record identifier for each document item to be priced;
retrieving, in a single query, data of pricing condition records of each pricing condition identifier, the data of each pricing condition record including at least one of price data and an indicator of whether scaled pricing data exists for the pricing condition; and
for each retrieved pricing condition record, write, to a first data structure buffered in the at least one memory, a pricing condition type identifier, an order identifier of the respective pricing condition type, an identifier of the document item to be priced, the pricing condition record identifier, and the indicator of whether scaled pricing data exists for the pricing condition record; and
for all pricing condition records of the first data structure buffered in the at least one memory, retrieving, in a single query, pricing data and writing the retrieved pricing data to a second data structure buffered in the at least one memory
price each document item to be priced based on the data of the first and second data structures buffered in the at least one memory.

16. The system of claim 15, wherein for each identified pricing condition type with regard to each document item to be priced, the retrieving of the pricing condition record identifier from the pricing condition tables is performed according to the sequence of pricing condition table identifiers until a pricing condition record identifier has been retrieved for the respective document item to be priced, after which, pricing condition record identifiers are retrieved only for document items to be priced for which a pricing condition record identifier has yet to be retrieved.

17. The system of claim 15, wherein:
the document is an invoice to be generated for each of a plurality of customers, each of the plurality of customers including at least one document item to be priced;
determining a pricing procedure for the document based on the at least one of the document type and the customer identifier includes:
determining a pricing procedure for each of the plurality of customers for which an invoice is to be generated; and
the pricing procedure for each of the plurality of customers identifying a sequence of pricing condition types to apply to document items to be priced for the respective customer; and
the instructions set including further instructions executable by the at least one processor to:
write, to a third data structure buffered in the at least one memory, data representative of the respective customer, pricing condition types to be applied to document items, and data representative of the sequence the pricing condition types are to be applied.

18. The system of claim 17, wherein the retrieving, in the single query from the pricing condition table of the respective pricing condition table identifier, is performed in the single query with regard to each document item of each of the plurality of customers.

19. The system of claim 17, wherein the first and third data structures are the same data structure.

20. The system of claim 15, wherein the identified ordered pricing condition types include a document item price condition type, at least one document item discount condition type, and at least one document item legal condition type.
